(19) United States
(12) Patent Application Publication
(10) Pub. No.: US 2008/0145753 A1
(43) Pub. Date: Jun. 19, 2008

(54) Non-magnetic lithium ion secondary electrochemical cell

(76) Inventors: David M. Spillman, Tonawanda, NY (US); Esther Sans Takeuchi, East Amherst, NY (US)

Correspondence Address: Greatbatch Ltd., 10,000 Wehrle Drive, Clarence, NY, 14031, US

(21) Appl. No.: 11/026,064

(22) Filed: Dec. 30, 2004

Related U.S. Application Data
(60) Provisional application No. 60/533,755, filed on Dec. 31, 2003.

(51) Int. Cl. H01M 2/02; H01M 4/66; H01M 2/30; H01M 10/04

(52) U.S. Cl. 429/176; 429/245; 429/178; 29/623.1

(57) ABSTRACT

A non-magnetic lithium ion secondary electrochemical cell is described. Use of titanium results in an electrochemical cell that is virtually non-magnetic in comparison to prior-art cells. Such cells are particularly desirable for use with implantable medical devices since they do not cause a significant distortion in the image provided by a Magnetic Resonance Imaging (MRI) system.

### CROSS REFERENCE TO RELATED APPLICATION

This application claims priority from U.S. provisional application Ser. No. 60/533,755, filed Dec. 31, 2003.

### BACKGROUND OF THE INVENTION

1. Field of the Invention

The present invention generally relates to a lithium electrochemical cell, and more particularly, to a lithium ion electrochemical cell. More particularly, the present invention is directed to a lithium ion secondary electrochemical cell that has a reduced magnetic signature. This makes the cell particularly useful with implantable medical devices since the cells cause less distortion in the image provided by a Magnetic Resonance Imaging (MRI) system.

2. Prior Art

Modern medical technology now allows medical technicians, doctors and surgeons to obtain clinically important information, i.e. images, using a Magnetic Resonance Imaging system. One requirement for using MRI equipment is that objects located in close proximity to the machine be non-magnetic so that they do not severely distort the visual image. The amount that a visual image is distorted depends primarily on the magnetic signature of a given material, and its proximity to the MRI machine. In practice, magnetic objects are generally not allowed in close proximity to the MRI system. For patients that have an implanted biomedical device, this can be a serious drawback as the magnetic signature of these devices can adversely affect the quality of the image.

Many implantable biomedical devices, such as cardiac defibrillators, left ventricular assist devices, artificial hearts, and neurostimulators, require the use of a hermetically sealed power source. Present day lithium ion electrochemical cells can be fabricated using many non-magnetic components. However, the anode current collector in a lithium ion cell is typically fabricated from copper and is attached to a stainless steel or nickel plated steel case enclosure using a nickel lead. Nickel in particular is magnetic in nature, and may affect the quality of the MRI image. Therefore, there exists the need for a lithium ion secondary electrochemical cell that has a relatively low magnetic signature and is acceptable for use in close proximity to an MRI machine.

### SUMMARY OF THE INVENTION

The present invention describes a lithium ion secondary electrochemical cell useful as a power source for an implantable biomedical device. The cells use electrode materials that are capable of intercalating and de-intercalating lithium ions. The anode material preferably contains a carbon material mixed with a suitable binder. This mixture is laminated or pressed onto a copper or titanium current collector. Copper and titanium are good conductors of electrons with relatively low magnetic susceptibilities of 182×10⁶ or less. Further, it has been discovered that titanium is an electrochemically stable material in the lithium ion cell system. The titanium current collector is attached to the cell enclosure by means of a titanium lead.

These and other aspects of the present invention will become more apparent to those skilled in the art by reference to the following description and the appended drawings.

### BRIEF DESCRIPTION OF THE DRAWINGS

FIG. 1 is a graph of the capacity fade of two lithium ion cells according to the present invention charged under a maximum current of 50 mA and discharged at 20 mA.

FIG. 2 is a graph of the capacity fade of two lithium ion cells according to the present invention charged under a maximum current of 20 mA and discharged at 10 mA.

FIG. 3 is a graph of the capacity fade of two lithium ion cells according to the present invention charged under a maximum current of 20 mA and discharged at 1 mA.

### DETAILED DESCRIPTION OF THE PREFERRED EMBODIMENTS

Lithium ion secondary electrochemical cells built according to the present invention exhibit a relatively low magnetic signature. Using copper or titanium for the anode current collector that attaches to a titanium casing or enclosure accomplishes this as these materials have magnetic susceptibilities of 182×10⁶ or less.

A secondary electrochemical cell constructed according to the present invention includes lithium as an anode active material. The anode or negative electrode comprises an anode material capable of intercalating and de-intercalating the lithium anode active material. A carbonaceous negative electrode comprising any of the various forms of carbon (e.g., graphitic carbons, non-graphitic carbons, petroleum cokes, pitch carbons, synthetic carbons, mesocarbon microbeads, etc.), which are capable of reversibly retaining the lithium species, is preferred for the anode material. A “hairy carbon” material is particularly preferred due to its relatively high lithium-retention capacity. “Hairy carbon” is a material described in U.S. Pat. No. 5,443,928 to Takeuchi et al., which is assigned to the assignee of the present invention and incorporated herein by reference. Graphite is another preferred material. Regardless the form of carbon, fibers of the carbonaceous material are particularly advantageous because they have excellent mechanical properties that permit them to be fabricated into rigid electrodes capable of withstanding degradation during repeated charge/discharge cycling. Moreover, the high surface area of carbon fibers allows for rapid charge/discharge rates.

A typical negative electrode is fabricated by mixing about 90 to 97 weight percent “hairy carbon” or graphite with about 3 to 10 weight percent of a binder material, which is preferably a fluoro-resin powder such as polytetrafluoroethylene (PTFE), polyvinylidene fluoride (PVDF), polyethylenetetrafluoroethylene (ETFE), polyamides, polyimides, and mixtures thereof. This negative electrode admixture is provided on a copper or titanium current collector in the form of a foil or screen (perforated or expanded) by casting, pressing, rolling or otherwise contacting the admixture thereto. Typically, the thickness of the copper or titanium foil may vary from about 0.0002 inches to about 0.0015 inches. The negative electrode further has an extended tab or lead. As will be described hereinafter, the lead is welded to a titanium cell case in a case-negative electrical configuration.

Preferably, the anode material and binder are thoroughly mixed with an organic solvent such as N-methyl-pyrrolidimone to form an admixture slurry. This slurry is coated on both sides of the titanium current collector. The resulting negative electrode is then pressed to a final total thickness of less than about 0.15 mm., and more preferably less than about 0.11 mm.

The cathode or positive electrode preferably comprises a lithiated material as a cathode active material that is stable in air and readily handled. Examples of such air-stable lithiated cathode active materials include oxides, sulfides, selenides, and tellurides of such metals as vanadium, titanium, chromium, copper, molybdenum, niobium, iron, nickel, cobalt and manganese. The more preferred oxides include LiNiO₂, LiMn₂O₄, LiCoO₂, LiCo_{0.92}Sn_{0.08}O₂, LiCo₁₋ₓNiₓO₂, and lithium vanadium oxide.

The lithiated active material is preferably mixed with a conductive additive. Suitable conductive additives include acetylene black, carbon black and/or graphite. Metals such as nickel, aluminum, titanium and stainless steel in powder form are also useful as conductive diluents when mixed with the above listed active materials. The positive electrode further comprises a fluoro-resin binder, preferably in a powder form, such as PTFE, PVDF, ETFE, polyamides, polyimides, and mixtures thereof.

Aluminum is a particularly preferred material for the cathode current collector since it is very conductive, non-magnetic, relatively inexpensive and stable within the confines of the battery environment. The aluminum cathode current collector is in the form of a foil or screen contacted with the cathode active mixture by casting, pressing, rolling, and the like.

Preferably, the cathode active mixture comprising the lithiated material, binder and conductive diluent are thoroughly mixed with an organic solvent such a N-methyl-pyrrolidimone to form an active admixture slurry. This slurry is coated on both sides of the aluminum cathode current collector. The resulting positive electrode is then pressed to a final total thickness of less than about 0.15 mm., and more preferably less than about 0.11 mm. thick.

The secondary cell of the present invention includes a separator to provide physical segregation between the negative and positive electrodes. The separator is of an electrically insulative material to prevent an internal electrical short circuit condition, and the separator material also is chemically unreactive with the negative and positive electrodes including the anode and cathode active materials and both chemically unreactive with and insoluble in the electrolyte. In addition, the separator material has a degree of porosity sufficient to allow flow there through of the electrolyte during the electrochemical reactions of the cell. The form of the separator typically is a sheet that is placed between the negative and positive electrodes.

Illustrative separator materials include fabrics woven from fluoropolymeric fibers of polyethylenetetrafluoroethylene and polyethylenechlorotrifluoroethylene used either alone or laminated with a fluoropolymeric microporous film. Other suitable separator materials include non-woven glass, polypropylene, polyethylene, glass fiber materials, ceramics, a polytetraflouroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C. H. Dexter, Div., Dexter Corp.).

The choice of an electrolyte solvent system for activating a fully charged lithium ion cell is very limited due to the high potential of the cathode material (up to 4.3 V vs. Li/Li⁺ for Li/Li₁₋ₓCoO₂) and the low potential of the anode material (0.01 V vs. Li/Li⁺ for graphite). According to the present invention, suitable nonaqueous electrolytes are comprised of an inorganic salt dissolved in a nonaqueous solvent and more preferably a lithium salt dissolved in a quaternary mixture of organic carbonate solvents comprising dialkyl (non-cyclic) carbonates selected from dimethyl carbonate (DMC), diethyl-carbonate (DEC), dipropyl carbonate (DPC), ethylmethyl carbonate (EMC), methylpropyl carbonate (MPC), ethylpropyl carbonate (EPC), and mixtures thereof, and at least one cyclic carbonate selected from propylene carbonate (PC), ethylene carbonate (EC), butylene carbonate (BC), vinylene carbonate (VC), and mixtures thereof. Organic carbonates are generally used in the electrolyte solvent system for such battery chemistries because they exhibit high oxidative stability toward cathode active materials and good kinetic stability toward anode active materials.

Preferred electrolytes comprise solvent mixtures of EC:DMC:EMC:DEC. Most preferred volume percent ranges for the various carbonate solvents include EC in the range of about 20% to about 50%; DMC in the range of about 12% to about 75%; EMC in the range of about 5% to about 45%; and DEC in the range of about 3% to about 45%. In a preferred form, the electrolyte activating the cell is at equilibrium with respect to the ratio of DMC:EMC:DEC. This is important to maintain consistent and reliable cycling characteristics. It is known that due to the presence of low-potential (anode) materials in a charged cell, an un-equilibrated mixture of DMC:DEC in the presence of lithiated graphite (LiC₆ about 0.01 V vs Li/Li⁺) results in a substantial amount of EMC being formed. When the concentrations of DMC, DEC and EMC change, the cycling characteristics and temperature rating of the cell change. Such unpredictability is unacceptable. This phenomenon is described in detail in U.S. Pat. No. 6,746,804 to Gan et al., which is assigned to the assignee of the present invention and incorporated herein by reference. Electrolytes containing such quaternary carbonate mixtures exhibit freezing points below −50° C., and lithium ion cells activated with such mixtures have very good cycling behavior at room temperature as well as very good discharge and charge/discharge cycling behavior at temperatures below −40° C. Another preferred solvent system is a 30:70 by volume mixture of EC/DMC.

Known lithium salts that are useful as a vehicle for transport of lithium ions from the negative electrode to the positive electrode, and back again include LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof. Suitable salt concentrations typically range between about 0.8 to 1.5 molar.

To charge such secondary cells, the lithium metal comprising the positive electrode is intercalated into the carbonaceous negative electrode by applying an externally generated electrical potential to the cell. The applied recharging electrical potential serves to draw lithium ions from the cathode active material, through the electrolyte and into the carbonaceous material of the negative electrode to saturate the carbon. The resulting LiₓC₆ negative electrode can have an x ranging from about 0.1 to about 1.0. The cell is then provided with an electrical potential and discharged in a normal manner.

An alternate secondary cell construction comprises intercalating the carbonaceous material with the active lithium material before the negative electrode is incorporated into the cell. In this case, the positive electrode body can be solid and comprise, but not be limited to, such materials as manganese dioxide, silver vanadium oxide, copper silver vanadium oxide, titanium disulfide, copper oxide, copper sulfide, iron sulfide, iron disulfide, carbon, and fluorinated carbon. However, this approach is compromised by the problems associated with handling lithiated carbon outside of the cell. Lithiated carbon tends to react with explosive results when contacted by air.

The preferred chemistry for the present rechargeable cells has a positive electrode of 91% LiCoO₂, 6% graphite additive and 3% PVDF binder, by weight, contacted to aluminum foil current collector, and a negative electrode of 91.7% graphite and 8.3% PVDF binder, by weight, on a titanium foil. This couple is activated with the quaternary carbonate solvent system of DMC, DEC, EMC and EC having a lithium salt electrolyte dissolved therein.

The anode assembly, the separator and the cathode assembly are wound around a mandrel that is suitable for the geometry of the cell. The two electrodes and separator are wound into a prismatic spiral or jellyroll configuration. In some instances, the electrode assembly may be wound into an elliptical configuration and then flattened to conform to the geometry of the case enclosure. In order to provide for maximum safety in the design, the width of the cathode assembly is smaller than that of the anode assembly and the cathode material is completely bounded by the anode material so as to prevent lithium plating. Therefore, the portion of the anode assembly that contains electrochemically active components extends beyond the cathode assembly at the beginning and at the end of the wound electrode assembly. Should the electrochemically active cathode material laminated to the aluminum cathode current collector not be completely opposed by electrochemically active anode material laminated to the copper or titanium anode current collector, the possibility exists that lithium metal may plate within the cell. This is undesirable as it may compromise the performance or the safety of the cell. Finally, it should be noted that the separator length and width extend beyond that of the anode assembly.

After the electrode assembly is wound and inserted into the case enclosure, the anode lead is welded to the titanium case. Depending on the cell design, the anode lead may be welded to the inside of the case or to the underside of the lid or header. Additionally, it may be pinched between the header and the case, and subsequently fused as the header and case are hermetically welded together. Methods of welding the anode lead to the case, to the header or to both include resistance welding, plasma welding, ultrasonic welding or laser welding. Depending upon the manner in which the cell is designed, however, it may be desirable to press fit the anode material admixture to the titanium case, in which case the copper or titanium current collector and lead may not be required.

The cell header comprises a metallic disc-shaped body with a first hole to accommodate a glass-to-metal seal/terminal pin feedthrough and a second hole for electrolyte filling. The glass used is of a corrosion resistant type having up to about 50% by weight silicon such as CABAL 12, TA 23, FUSITE 425 or FUSITE 435. The positive terminal pin feedthrough preferably comprises titanium although molybdenum, niobium, aluminum, nickel alloy, or stainless steel can also be used. The cell header is of titanium, which is the same material as the case. The header welded to the case containing the electrode stack in turn, supports the positive terminal pin supported in the glass-to-metal seal. The cell is thereafter filled with the electrolyte solution described hereinabove and hermetically sealed such as by close-welding a titanium ball over the fill hole, but not limited thereto. The cell is then subjected to a formation process consisting of one or more charge and discharge cycles.

In accordance with the stated low magnetic susceptibility characteristics of the electrochemical cell of the present invention, Table 1 lists the magnetic susceptibilities of the various materials used to construct the cell along with selected other materials.

TABLE 1

| | | Atomic or | |
|---|---|---|---|
| | Density | Molecular | Susceptibility |
| Material | (g/cc) | Weight | (×10⁶) |
| Carbon | 2.26 | 12.011 | −218 |
| (polycrystalline | | | |
| graphite) | | | |
| Gold | 19.32 | 196.96 | −34 |
| Beryllium | 1.85 | 9.012 | −24 |
| Silver | 10.50 | 107.87 | −24 |
| Carbon (diamond) | 3.513 | 12.011 | −21.8 |
| Zinc | 7.13 | 65.39 | −15.7 |
| Copper | 8.92 | 63.546 | −9.63 |
| Water (37° C.) | 1.00 | 18.015 | −9.03 |
| Human Soft | ~1.00-1.05 | — | ~(−11.0 to −7.0) |
| Tissues | | | |
| Aluminum | 2.70 | 26.98 | +20.7 |
| Titanium | 4.54 | 47.88 | 182 |
| Chromium | 7.19 | 51.996 | 320 |
| Stainless Steel | 8.0 | — | 3520-6700 |
| (nonmagnetic, | | | |
| austenitic) | | | |

In contrast, Table 2 lists the magnetic susceptibilities of various relatively highly magnetic materials.

TABLE 2

| | | Atomic or | |
|---|---|---|---|
| | Density | Molecular | |
| Material | (g/cc) | Weight | Susceptibility |
| Nickel | 8.9 | 58.69 | 600 |
| Stainless Steel | 7.8 | — | 400-1100 |
| (magnetic, | | | |
| martensitic) | | | |
| Iron | 7.874 | 55.874 | 200,000 |

The data used to construct Tables 1 and 2 was obtained from a paper authorized by John Schneck of General Electric Corporate Research and Development Center, Schenectady, N.Y. 12309. entitled “The Role of Magnetic Susceptibility In Magnetic Resonance Imaging: Magnetic Field Compatibility of the First and Second Kinds”. The disclosure of that paper is incorporated herein by reference.

Accordingly, the present electrochemical cell is useful for powering a wide variety of medical devices including pacemakers, neurostimulators, implantable drug pumps and cardiac defibrillators. That way, a patient who may require one of these devices to live is not precluded from having the benefits of magnetic resonance imaging procedures to sustain an acceptable quality of life.

The following examples describe the present invention, and they set forth the best mode contemplated by the inventors of carrying out the invention, but they are not to be construed as limiting.

### EXAMPLE I

Six lithium ion electrode assemblies were inserted into their own titanium cases. The anodes for the assemblies comprised a mixture of carbon (LK703 graphite) and 3% PVDF binder contacted to a copper current collector. The cathodes comprised a mixture of LiCoO₂ with 3% carbon additive and 3% PVDF binder contacted to an aluminum current collector. A polyethylene separator (shutdown) segregated the anode from the cathode. The electrode assemblies were activated with an electrolyte of 1.0 M LiPF₆ in a 30:70, by volume, mixture of EC:DMC. The titanium cases were hermetically sealed with a titanium lid with the molybdenum cathode terminal pin insulated there from by Cabal-12 glass. The cells had about 120 mAh of capacity.

The cells were subjected to cycle testing at 37° C. The cells were charged at a constant voltage of 4.10 volts and a maximum charge current until the current tapered to 10 mA. Then, they were further charged at 5 mA until the charge current tapered down to 2 mA. After charging, the cells were allowed to equilibrate for thirty minutes and were then discharged to 2.75 volts at a specific discharge rate. Following discharge, the cells were allowed to equilibrate for an additional thirty minutes prior to recharging. Two cells (Group I) were charged under a maximum current of 50 mA and discharged at 20 mA, two cells (Group II) were charged under a maximum current of 20 mA and discharged at 10 mA, and two cells (Group III) were charged under a maximum current of 20 mA and discharged at 1 mA.

The Group I cells cycled at the highest rate achieved 1,000 cycles. Electrical tests on the Group II cells charged at a maximum current of 20 mA and discharged at 10 mA were terminated after 650 or 750 cycles. The Group III cells, charged at a maximum current of 20 mA and discharged at 1 mA, were terminated after 150 cycles, or about two years. This low number of cycles is partially attributed to the very low discharge rate, i.e. three to five days per cycle, and the fact that the cells were maintained at nearly 4.10 volts for about one year prior to cycling.

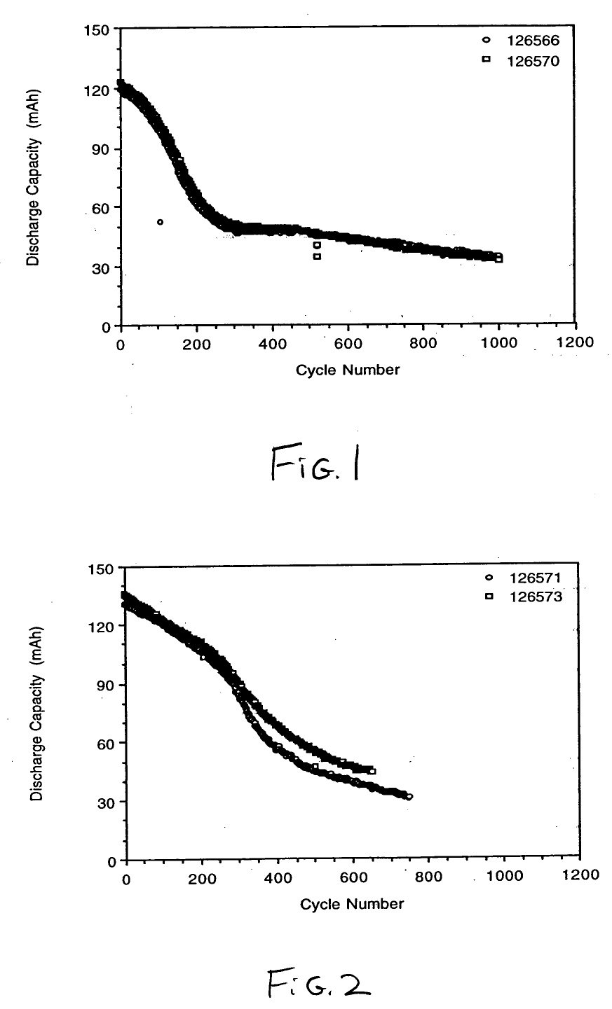

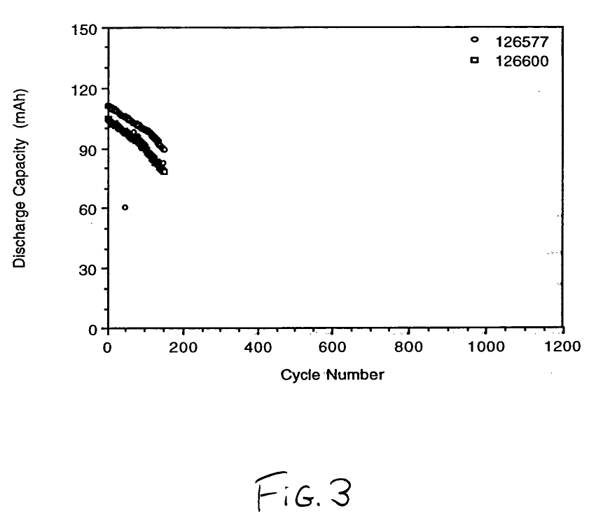

For each cell tested, the cycle data is summarized in Table 1 and plotted in FIGS. 1 to 3. The percent capacity retention, which was based on the capacity delivered during cycle ten, is summarized in Table 2.

The Group I cells, which were charged at a maximum current of 50 mA and discharged at 20 mA, provided about 200 to 250 cycles before the capacity decreased to below 50% of that achieved on cycle ten, i.e. the runtime was less than three hours at this rate. After 1,000 cycles, these two cells provided about 25 to 30% of the capacity delivered on cycle ten.

For the Group II cells, which were charged at a maximum current of 20 mA and discharged at 10 mA, the observed fade rate was lower. Under these conditions of use, 350 to 450 cycles were obtained before the capacity decreased to lower than 50% of that delivered on cycle ten, i.e. the runtime was less than six hours at this rate.

For the Group III cells, which were charged at a maximum current of 20 mA and discharged at 1 mA, the observed fade rate was higher than that for the Group II cells, but lower than that observed for the Group I cells charged and discharged at the maximum rate. When this test was terminated after 150 cycles, the capacity retention was about 78% to 89%, i.e. the runtime was still greater than three days per cycle at this rate. As discussed earlier, these two cells were first stored for one year at 37° C. prior to being cycled. This resulted in a lower initial capacity.

### EXAMPLE II

Ten lithium ion cells identical to those used in Example I were subjected to a formation procedure. This consisted of charging the cells at a constant voltage of 4.10 volts and a maximum charge current until the current tapered to 10 mA. Then, they were further charged at 5 mA until the charge current tapered down to 2 mA. Following formation, the cells were cycled at either 37° C. or 50° C. Periodically, one cell from each temperature was removed from storage after 3, 6, 12, 24, 36 months and subjected to destructive analysis. Particular attention was paid to the stability of the titanium components and the glass-to-metal seal. The open circuit voltage of these cells was checked monthly, and maintained between 3.90 and 4.10 volts. To date, none of the cells exhibit any evidence of leakage.

In conclusion, lithium ion cells encased in titanium and subjected to the cycling conditions described above did not exhibit any catastrophic decreases in discharge capacity. These cycle tests indicate that the present lithium ion cells housed in a titanium case may be cycled hundreds of times, and remain stable after 4.5 years of storage at temperatures up to 50° C. This storage time/temperature should be sufficient for using the present cells as the power source for implantable medical devices.

It is appreciated that various modifications to the inventive concepts described herein may be apparent to those of ordinary skill in the art without departing from the scope of the present invention as defined by the appended claims.

What is claimed is:

1. An electrochemical cell that is intended for use in the vicinity of a magnetic resonance imaging machine, which comprises:
a) an anode;
b) a cathode of a cathode active material that is capable of intercalation or insertion of lithium;
c) a separator preventing direct physical contact between the anode from the cathode;
d) an electrolyte activating the anode and the cathode; and
e) a casing housing the anode and the cathode, wherein the casing is of a material having a magnetic susceptibility of 182×10⁶ or less.

2. The electrochemical cell of claim 1 wherein the casing is of titanium.

3. The electrochemical cell of claim 1 wherein the anode includes a current collector of either copper or titanium.

4. The electrochemical cell of claim 1 wherein the cathode includes a current collector of aluminum.

5. The electrochemical cell of claim 1 provided in a case-negative design wherein the anode contacts the casing of titanium as the negative terminal and the cathode active material is contacted to an aluminum current collector in electrical continuity with a terminal pin.

6. The electrochemical cell of claim 1 as a secondary cell having a carbonaceous anode and a cathode active material selected from the group consisting of LiNiO₂, LiMn₂O₄, LiCoO₂, LiCo_{0.92}Sn_{0.08}O₂, LiCo₁₋ₓNiₓO₂, and mixtures thereof.

7. The electrochemical cell of claim 1 wherein the electrolyte comprises at least one solvent selected from the group consisting of dimethyl carbonate, diethyl carbonate, dipropyl carbonate, ethylmethyl carbonate, methylpropyl carbonate, ethylpropyl carbonate, propylene carbonate, ethylene carbonate, butylene carbonate, vinylene carbonate, and mixtures thereof.

8. The electrochemical cell of claim 1 wherein the electrolyte comprises a salt selected from the group consisting of LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

9. An electrochemical cell that is intended for use in the vicinity of a magnetic resonance imaging machine, which comprises:
a) an anode of a carbonaceous material contacted to an anode current collector of either copper or titanium;
b) a cathode of a cathode active material that is capable of intercalation or insertion of lithium contacted to a cathode current collector of aluminum;
c) a separator preventing direct physical contact between the anode from the cathode;
d) an electrolyte activating the anode and the cathode; and
e) a casing housing the anode and the cathode, wherein the casing, the anode current collector and the cathode current collector are of materials having magnetic susceptibilities of 182×10⁶ or less.

10. A method for providing an electrochemical cell intended for use in the vicinity of a magnetic resonance imaging machine, comprising the steps of:
a) providing an anode and an associated cathode of a cathode active material that is capable of intercalating or inserting lithium;
b) preventing direct physical contact between the anode from the cathode with a separator;
c) housing the anode and the cathode in a casing of a material having a magnetic susceptibility of about 182×10⁶ or less; and
d) activating the anode and the cathode with an electrolyte hermetically sealed inside the casing.

11. The method of claim 10 including providing the casing of titanium.

12. The method of claim 10 including providing the anode including a current collector of either copper or titanium.

13. The method of claim 10 including providing the cathode including a current collector of aluminum.

14. The method of claim 10 including providing the cell in a case-negative design wherein the anode contacts the casing of titanium as the negative terminal and the cathode active material is contacted an aluminum current collector in electrical continuity with a terminal pin.

15. The method of claim 10 including providing the cell having a carbonaceous anode and a cathode active material selected from the group consisting of LiNiO₂, LiMn₂O₄, LiCoO₂, LiCo_{0.92}Sn_{0.08}O₂, LiCo₁₋ₓNiₓO₂, and mixtures thereof.
